(19) United States
(12) Patent Application Publication
(10) Pub. No.: US 2001/0031040 A1
(43) Pub. Date: Oct. 18, 2001

(54) Line test apparatus with vibratory element

(76) Inventors: Paul Kaine, St. Arvans (DE); Jonathan Rees, S. Wales (DE)

Correspondence Address: CAHILL, SUTTON & THOMAS P.L.C., Attn: Marvin A. Glazer, 155 Park One, 2141 East Highland Avenue, Phoenix, AZ, 85016, US

(21) Appl. No.: 09/792,714

(22) Filed: Feb. 23, 2001

(30) Foreign Application Priority Data
Feb. 24, 2000 (GB) 0004424.8

(51) Int. Cl. H04M 1/24; H04M 3/22

(52) U.S. Cl. 379/21; 379/22.02; 379/22.01

(57) ABSTRACT

A line test apparatus includes a hand-held body having a sensor probe tip for capacitively or inductively sensing the presence of an audio signal within a conductor under test, or within a conductor pair under test. The probe tip delivers an electrical input signal to an amplifier housed within such body; the electrical amplifier serves to amplify the signal and produces an amplified electrical output signal at an output terminal thereof. A vibratory element is electrically coupled to the output terminal of the amplifier for vibrating with an intensity corresponding to the magnitude of the sensed audio signal. Other output transducers, such as LEDs and/or a loudspeaker, may also be included for providing visual and/or audible output signals indicating the presence and magnitude of the sensed audio signal.

### BACKGROUND OF THE INVENTION

1. Field of the Invention

The present invention relates to apparatus for use in testing and/or identifying conductors, such as telephone lines. It particularly relates to apparatus comprising a sensor unit for sensing a signal carried by a conductor.

2. Description of the Relevant Art

A known form of apparatus employs a signal applicator for applying a signal to a conductor, e.g. applying a signal to a telephone wire pair, e.g. at an exchange. At a remote point, the conductor is found and/or identified (typically from numerous like conductors), by means of a sensor probe. Typically this has a thin non-contact sensor element, which can be placed near, or inserted between, the wires of a conductor pair to pick up a signal carried by them. The sensor includes an amplifier for amplifying the signal. Its presence must then be made known. Typically the signal applied to the conductor is an audio signal, so that the signal picked up by the probe can be detected by applying the amplified output to a loudspeaker.

However such probes often have to be used in very noisy environments, such as busy streets, where road works may be generating considerable noise. Thus an audio output may be difficult to detect. Some sensors have visual displays, e.g. lines of LED's lighting up to provide an indication of signal strength. However this is still not ideal. An engineer may need to be looking elsewhere, e.g. at the position of his sensor element; and lighting conditions may make the visual displays hard to see.

### SUMMARY OF THE INVENTION

According to the present invention there is provided a sensor probe having means for detecting a signal carried by a conductor and generating a detectable output, wherein the detectable output is provided by means comprising a vibratory element. There may also be one or more other detectable outlet means, e.g. auditory and/or visual which may be operable simultaneously or selectively. The probe may be electrostatic type (e.g. based on a single-ended capacitive element). This is suitable for detecting a varying voltage signal on an open circuit. If the conductor is looped wire with a significant signal current flowing, the probe may be inductive, typically employing a coil which may be provided by a pattern on a circuit board.

The vibratory element may be arranged to vibrate in a manner indicative of signal strength.

The vibratory element may be part of a hand-held device or may be adapted to be worn or mounted elsewhere where vibrations may be readily detected, e.g. in an inside shirt or jacket pocket.

Vibratory alerting devices are already known, e.g. in pagers and mobile telephones for use in a noisy environment. The same technology may be applied, with appropriate modification, to a sensor probe embodying the present invention.

### BRIEF DESCRIPTION OF THE DRAWINGS

An embodiment of the invention will now be described with reference to the accompanying drawings wherein:

FIG. 1 is a schematic block diagram of a sensor probe embodying the invention; and

FIG. 2 is a schematic view showing the use of line test apparatus embodying the invention.

### DETAILED DESCRIPTION OF THE PREFERRED EMBODIMENT

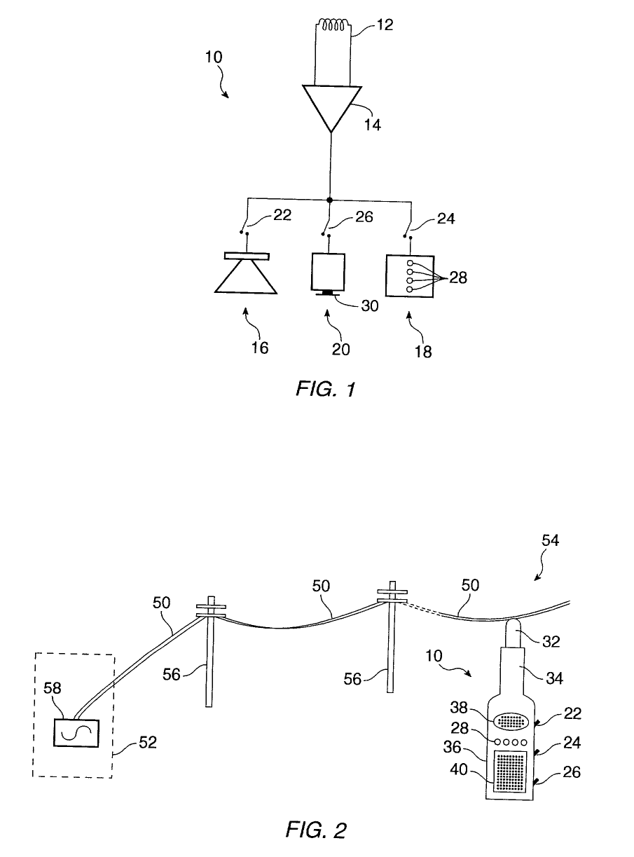

FIG. 1 shows a sensor probe unit 10 having an inductive coil pick-up 12 coupled to an amplifier 14. (Alternatively the pick-up 12 could be an electrostatic, capacitive pick-up.) The amplified output can be selectively passed to any one or more of three signal transducers 16, 18, 20 via respective switches 22, 24, 26. The first transducer 16 is a loudspeaker. The second transducer 18 has an array (here four) of light emitting diodes 28, and circuitry such that the patterns of illumination of the diodes is indicative of signal strength. The third transducer 20 has a vibratable plate 30 and driving circuitry for causing the plate to vibrate with a magnitude indicative of signal strength.

FIG. 2 shows the probe unit 10 as a hand-held unit. The pick-up 12 is in a flat top portion 32 of an elongate probe arm 34 which extends from a body 36. The body has switches 22, 24, 26 and associated transducers 16, 18, 20. This has a grille 38 to allow sound from an internal speaker 16 to escape, and an array of LED's 28. The body 36 is shaped and dimensioned so that it can conveniently be held in one hand, with the hand contacting a flexible protective cover 40 overlying the vibratable plate 30.

FIG. 2 also shows a telephone line 50 (conductor pair) extending from an exchange 52 to a remote region 54. It may travel underground and/or overhead, supported by telegraph poles 56. Of course there will generally be a multiplicity of essentially identical lines. At the exchange, a signal applicator device 58 is used to apply an audio frequency signal to the line 50. At the remote region 54, the line 50 is identified in the multiplicity of like lines by inserting the tip portion 32 between or near the wires of conductor pairs until the signal is detected by means of one or more of the transducers 16, 18, 20. The contact line 50 can be distinguished from other lines that may have picked up some signal by comparing intensities.

While the present invention has been described with respect to preferred embodiments thereof, such description is for illustrative purposes only, and is not to be construed as limiting the scope of the invention. Various modifications and changes may be made to the described embodiments by those skilled in the art without departing from the true spirit and scope of the invention as defined by the appended claims.

We claim:

1. A line test probe for detecting an electrical signal in a conductor under test, comprising in combination:
a. a body having first and second opposing ends;
b. a probe tip extending from the first end of the body for insertion proximate one or more conductors under test;
c. an electronic amplifier disposed within said body and having at least one input terminal electrically coupled with the probe tip for amplifying an electrical input signal sensed by the probe tip, the electronic amplifier including an output terminal for providing an electrical output signal derived from the electrical input signal; and
d. a vibratory element electrically coupled to the output terminal of the electronic amplifier and responsive to the electrical output signal for vibrating to indicate the presence of an electrical signal in the conductor under test.

2. The line test probe recited by claim 1 wherein the probe tip is a capacitive element for electrostatically sensing the presence of an electrical signal in a conductor under test.

3. The line test probe recited by claim 1 wherein the probe tip is an inductive coil element for inductively sensing the presence of an electrical signal in a conductor under test.

4. The line test probe recited by claim 1 wherein the vibratory element is disposed within the body.

5. The line test probe recited by claim 4 wherein the vibratory element is disposed generally within the second end of the body.

6. The line test probe recited by claim 1 wherein the vibratory element includes a vibratable plate and a driver for causing the vibratable plate to vibrate in response to the electrical output signal.

7. The line test probe recited by claim 1 wherein the electrical input signal has a magnitude, and wherein the electrical output signal also has a magnitude, and wherein the magnitude of the electrical output signal is substantially proportional to the magnitude of the electrical input signal.

8. The line test probe recited by claim 1 wherein the electrical output signal has a magnitude, and wherein the vibrator vibrates with a magnitude that increases as the magnitude of the electrical output signal increases.

9. The line test probe recited by claim 1 wherein the electrical input signal has a magnitude, and wherein the vibrator vibrates with a magnitude that increases as the magnitude of the electrical input signal increases.

10. The line test probe recited by claim 1 wherein the electrical output signal has a magnitude, and wherein the vibrator vibrates with a magnitude that is subs tantially proportional to the magnitude of the electrical output signal.

11. The line test probe recited by claim 1 wherein the electrical input signal has a magnitude, and wherein the vibrator vibrates with a magnitude that is substantially proportional to the magnitude of the electrical input signal.

12. The line test probe recited by claim 1 wherein the electrical signal in the conductor under test is an audio signal.

13. The line test probe recited by claim 1 including audible means coupled to the output terminal of the electronic amplifier for producing an audible signal in response to the electrical output signal.

14. The line test probe recited by claim 1 including audible means coupled to the output terminal of the electronic amplifier for producing a visual signal in response to the electrical output signal.
